(19) United States
(12) Patent Application Publication
(10) Pub. No.: US 2023/0073503 A1
(43) Pub. Date: Mar. 9, 2023

(54) SECURITY FILE SYSTEM FOR A MEMORY SYSTEM

(71) Applicant: MICRON TECHNOLOGY, INC., Boise, ID (US)

(72) Inventors: Ximin Shan, San Jose, CA (US); Jiangli Zhu, San Jose, CA (US)

(21) Appl. No.: 17/468,129

(22) Filed: Sep. 7, 2021

(51) Int. Cl. G06F 21/78; G06F 21/62; G06F 3/06

(52) U.S. Cl. CPC G06F 21/78; G06F 21/6218; G06F 3/0622; G06F 3/0632; G06F 3/0673

(57) ABSTRACT

A system can include a memory device and a processing device coupled with the memory device, the processing device can receive an identification command from a host system. The processing device can initiate a security procedure in response to receiving the identification command. The processing device can also send an access command to the memory device, the access command can include an identification of a first physical super management unit at a first location the memory device that stores a security file system, where data for the host system is stored at a second location of the memory device. The processing device can receive one or more files from the security file system in response to sending the access command and execute the security procedure in response to receiving the one or more files from the security file system.

### TECHNICAL FIELD

Embodiments of the disclosure relate generally to memory sub-systems, and more specifically, relate to a security file system for a memory system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method for accessing a security system file in accordance with embodiments of the present disclosure.

FIG. 3 is a flow diagram of an example method for accessing a security system file in accordance with embodiments of the present disclosure.

FIG. 4 is a block diagram of an example computer system in which embodiments of the present disclosure may operate.

### DETAILED DESCRIPTION

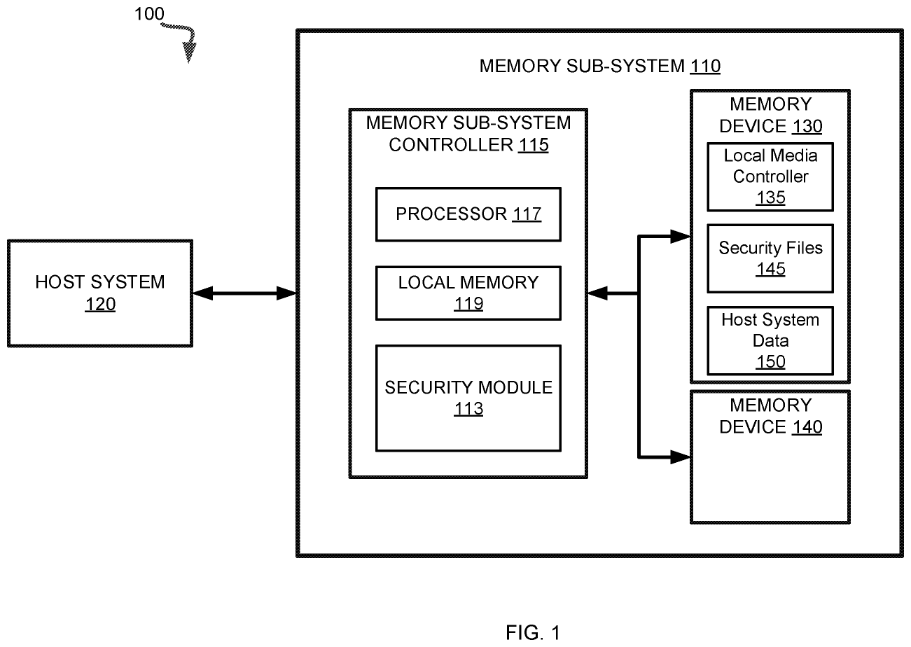

Aspects of the present disclosure are directed to a security file system for a memory system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, three-dimensional cross-point (“3D cross-point”) memory, which can include a cross-point array of non-volatile memory cells, offers storage in the form of compact, high density configurations. Other examples of non-volatile memory devices are described below in conjunction with FIG. 1. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are etched onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

Certain non-volatile memory devices (e.g., a three-dimensional cross-point memory device or NAND devices) can initiate a power on initialization following a reset—e.g., following a fundamental reset (PERST). In some instances, the reset can be a cold reset (e.g., when power is applied to the memory device or when the memory device powers up) or a warm reset (e.g., reset with power already applied to the memory device). In either instance, the memory device can rebuild (e.g., reconstruct) the memory device (rebuild the media) after the reset. For example, the rebuilding can include reconstructing or rebuilding a logical-to-physical (L2P) table each time following a reset of the memory device. During the initialization period (e.g., while the media is being rebuilt), the memory device can be inaccessible for reads, writes, erases (e.g., for access operations). Accordingly, a memory system controller (e.g., a frontend) that is coupled with the memory devices (e.g., a backend) can be unable to access any data on the memory devices until the memory device is rebuilt—e.g., until a media ready status is received.

Certain memory devices can initiate a security procedure as part of the power on initialization. For example, the memory system controller can have a security module that is initialized each time the memory device is reset. The security file system (e.g., the files for the security module) can be stored at the memory device. For instance, the security file system can be stored in an extended logical space that shares the same wear leveling algorithms used on data stored for a host system at the memory device—e.g., user data or user space. Accordingly, the security file system readiness (e.g., being available to access) can be related to the readiness of the data stored for the host system—e.g., inaccessible until the media ready status is received. Because the memory system controller is unable to access the security file system until the memory device is ready, the memory system controller can be delayed in responding to a host identify controller command from a host system following the reset. In some instances, the memory system can fail to respond to host system within a specified time or meet the specified time with little margin e.g., fail to meet a time specified by a peripheral component interconnect express standard (PCIe). In some memory devices, certain approaches have resorted to optimize the time it takes for the memory device to be ready. Such approaches can fail to meet the specified time. Other approaches have resorted to access a backup mode of the security file system—e.g., attempt to access the security file system before the memory device is ready. Such approaches can cause substantial boot up (e.g., power up initialization) code changes and cause additional inter-module synchronization (e.g., handshaking). The additional code changes and additional inter-module synchronization can lead to longer memory device ready times and cause the memory device to fail meeting the specified time.

Aspects of the present disclosure address the above and other deficiencies by providing a memory sub-system that can store a security file system that is separate from host system data. The security file system stored separate from the host system data can be accessible independent of a media ready status for the host system data. For example, the memory sub-system can store the security file system at a reserved physical super management unit (PSMU). The reserved PSMU can be separate from data stored for the host system (e.g., data stored for a user). For instance, the memory sub-system controller can refrain from performing typical wear leveling operations on the security file system at the reserved PSMU. Because the security file system is stored at the reserved PSMU, the security file system can be accessible even if the remaining host data is not. For example, when the memory sub-system starts a power up initialization (e.g., a boot up procedure), the memory sub-system controller can begin to rebuild the media stored at the memory device. The memory sub-system controller can also request the security file system at the same time—e.g., concurrently or simultaneously. The memory device can identify that the request is for the security files stored at the reserved PSMU and send the files to the memory sub-system controller while rebuilding the rest of the media. The memory sub-system controller can receive the security files and initialize the security module. The memory sub-system can then continue the power up initialization and respond to the host system.

Advantages of the present disclosure include, but are not limited to, reducing a time to complete the power up initialization. By accessing the security files without waiting for a media ready status (e.g., accessing the security files concurrent with the media rebuild), the memory sub-system can initialize the security module quicker. Accordingly, the memory sub-system can respond to a host identification controller command within the specified time. Additionally, because the reserved PSMU is separate from the host system data, the memory sub-system controller can access the security files at any time, even if the remaining media is degraded. Further, storing the security files at the PSMU can avoid increased media degradation effects. The reserved PSMU storing the security files can be written to less than a PSMU storing host data, accordingly the memory sub-system can refrain from performing wear leveling operations at the reserved PSMU. Instead, the memory sub-system can store a redundant copy and if the security file system at the reserved PSMU becomes corrupted (e.g., an error operation finds one or more errors), the memory sub-system can use the redundant copy to write the security file to a second reserved PSMU. Accordingly, the memory sub-system can avoid additional latencies while using a separate security file system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a security module 113 that can allow the memory sub-system 110 to initiate a security initialization procedure following a reset. In some embodiments, the memory sub-system controller 115 includes at least a portion of the security module 113. In some embodiments, the security module 113 is part of the host system 110, an application, or an operating system. In other embodiments, local media controller 135 includes at least a portion of security module 113 and is configured to perform the functionality described herein.

The security module 113 can be configured to initiate a security procedure (e.g., security initialization) if the memory sub-system controller 115 receives a host identity controller command following a reset. In some embodiments, the host system 120 can send the command to the memory sub-system 110 after a reset so the memory sub-system controller 115 can identify whether there are additional controllers in the system—e.g., are other controller associated with the same host system. To respond to the host identity controller command, the memory sub-system 110 can utilize a security file system. In at least one embodiment, the security file system can be stored at the memory device 130 or memory device 140. For example, memory device 130 can store security files 145 that form at least a portion of the security file system. The security files system 145 can be separate from the host system data 150. That is, the memory device 130 can store the security files system 145 in a first location (e.g., a first PSMU) and store the host system data 150 in a second location (e.g., a set of PSMUs that do not include the first PSMU). While the memory sub-system controller 115 is performing a boot up procedure following the reset (e.g., rebuilding the L2P table or other operations to rebuild the media stored at the memory device 130 to enable access to the host system data 150), the security module 113 can request the security file system stored at the security files 145. The memory device 130 can access the security files system 145 even if the host system data 150 is inaccessible and being rebuilt because the security file system 145 is stored at a separate location. The memory device 130 can recognize the request is for the security files 145 as the request can include a unique identification for the security files 145 stored at a reserved PSMU. Accordingly, the memory device 130 can access the security files 145 and send them back one or more files to the security module 113. The security module 113 can respond to the host identity controller command while the memory sub-system controller 115 continues the media rebuild. That is, the security module 113 can access the security files 145 while the memory device 130 continues to rebuild the host system data 150 stored at the memory device 130—e.g., the security module 113 can access the security 145 concurrent with the memory sub-system controller 115 performing the rebuild to access the host system data 150.

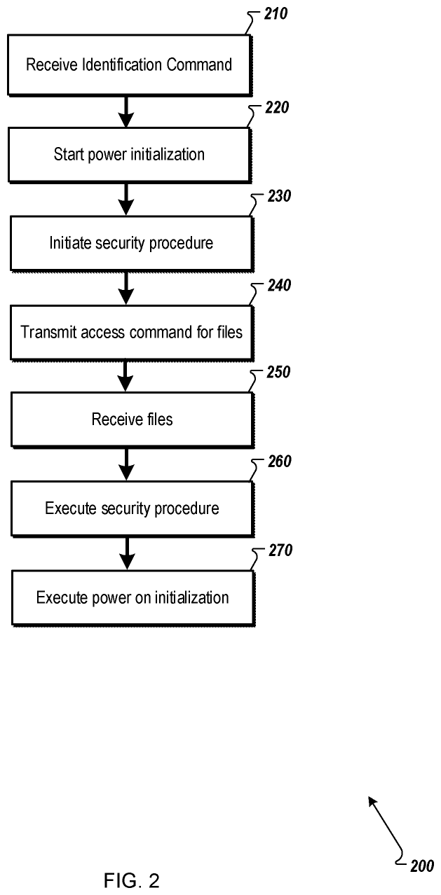

FIG. 2 is a flow diagram of an example method 200 to limit commands transmitted to a memory sub-system in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the security module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, processing logic can receive an identification command. For example, memory sub-system controller 115 can receive a host identify controller command from host system 120. In some embodiments, the host identify controller command can enable the memory sub-system controller to determine if other controllers are in the system. Additionally, the host identify controller command can allow the host system to logically map with the memory system controller. In some embodiments, the processing logic can receive the identification command after a reset of the memory sub-system—e.g., after a PERST. In one embodiment, the reset is a cold reset—e.g., a power is supplied to the memory sub-system to power the memory sub-system on.

At operation 220, processing logic can start a power on initialization procedure. For example, memory sub-system controller can start a power on (e.g., boot up) initialization after the reset—e.g., after the PERST. In some embodiments, after the reset occurs, the memory sub-system can reconstruct or rebuild the media (e.g., the memory devices). In at least one embodiment, the processing logic can rebuild the L2P table during the power initialization procedure. In some embodiments, the power initialization procedure can include additional rebuild operations. In some embodiments, while the power initialization procedure is performed, the memory sub-system controller is unable to access data stored for the host system (e.g., user data). That is, memory sub-system controller is unable to write to, read from, or erase physical locations storing the host system data.

At operation 230, the processing logic can start a security procedure. In at least one embodiment, the processing logic can perform the security procedure concurrent with the power initialization. For example, the processing logic can start and complete the security procedure while the power on initialization is performed. In at least one embodiment, the processing logic can identify what files the security module 113 will utilize for the security procedure. In an embodiment, the processing logic can perform the security procedure to respond to the host identify controller command.

At operation 240, the processing logic can transmit an access command for files utilized in the security procedure. In at least one embodiment, the memory device can store the security system files in a reserved PSMU that is separate from the host system. In such embodiments, the memory sub-system controller can access the security system files at the reserved PSMU even if the remaining host system data is inaccessible—e.g., still being rebuilt. Accordingly, when sending the access command, the processing logic can include an identification of the security file system stored at the reserved PSMU in the command. The memory device can identify that the command is for the reserved PSMU security system files when it receives the identification in the access command. In some embodiments, the memory device can also include a reserve copy (e.g., a redundant copy or second copy) of the security system files at a second PSMU. If the processing logic detects one or more errors with the security file system (e.g., detects errors as a result of an error correction (ECC) operation), the processing logic can copy the redundant security file system to a third reserved PSMU. In such embodiments, the processing logic can send access commands identifying the security system files stored at the third reserved P SMU.

At operation 250, the processing logic can receive the files requested from the security file system. In some embodiments, the processing logic can receive files that can identify the controller to the host system—e.g., files that can be used to determine if the memory sub-system controller is the only controller in the system. In other embodiments, the processing logic can receive files that map (e.g., logically map) the memory sub-system controller with the host system. In some embodiments, the processing logic can receive the files while performing the power up (e.g., boot up) procedure. That is, the processing logic can receive the files while the rest of the media is being rebuilt.

At operation 260, the processing logic can execute the security procedure. In some embodiments, the processing logic can respond to the host identity controller command after receiving the security files. In some embodiments, the processing logic can respond to the host identity controller command within a specified time based on being able to access the security file system before the remaining media is ready—e.g., based on the security file system being independent from the remaining host system data.

At operation 270, the processing logic can execute the power on initialization. In some embodiments, the processing logic can execute and finish the L2P table rebuilding and other operations associated with the media rebuild. In some embodiments, the processing logic can receive a media ready status—e.g., an indication that the host system data is ready and accessible. In some embodiments, the processing logic can execute the power on initialization concurrent with executing the security procedure. In some embodiments, the processing logic can complete the security procedure before completing the power on initialization—e.g., complete the security procedure before the processing logic receives the media ready status.

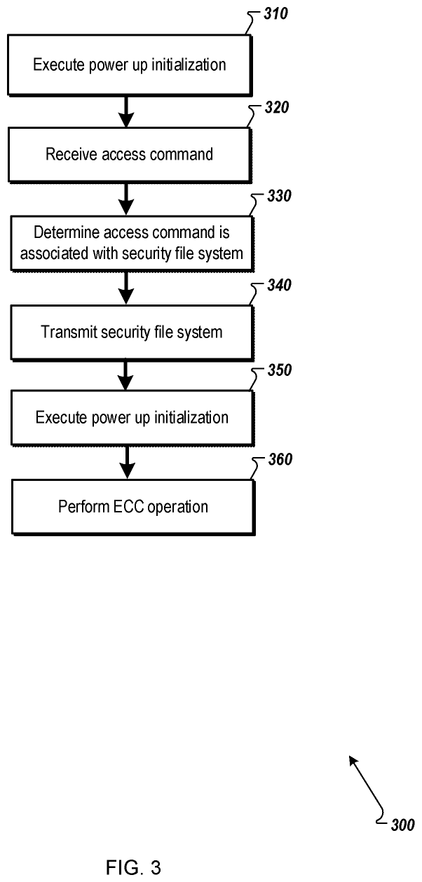

FIG. 3 is a flow diagram of an example method 300 to limit commands transmitted to a memory sub-system in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the security module 113 of FIG. 1. In some embodiments, the method 300 is performed by the local media controller 135 of the memory device 130. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic execute a power up initialization (e.g., boot up initialization). For example, a local media controller 135 can perform a power up initialization following a reset of the memory device. In some embodiments, the power up initialization can include rebuilding an L2P table or other operations to get the media at the memory device ready. In some embodiments, the memory device can perform the power up initialization in response to a command received from the memory sub-system controller. In some embodiments, the memory device can perform the power up initialization after the memory sub-system controller receives a host identify controller command.

At operation 320, the processing logic can receive an access command. In some embodiments, the local media controller can receive the access command from the memory sub-system controller. In at least one embodiment, the access command can include an identification—e.g., a file identification. In some embodiments, the local media controller can receive the access command while executing the power up initialization—e.g., concurrent with the power up initialization.

At operation 330, the processing logic can determine the access command received is associated with files at a security file system stored at a reserved physical super management unit (PSMU) of the memory device. In some embodiments, the memory device can store security system files at a reserved PSMU that is separate from memory locations that store the host system data—e.g., separate from other PSMUs that store the host system data. In at least one embodiment, the local media controller can access the reserved PSMU at any time—e.g., even while the remaining media is being rebuilt. In some embodiments, the files stored at the security file system can have unique identifiers. When the local media controller receives the access command, the local media controller can compare the identification received with the unique identifiers of the security file system. If the local media controller determines the identification in the access command is the same as the unique identifiers, the local media controller can access the files at the security file system.

At operation 340, the processing logic can send the security files requested. In some embodiments, the local media controller can send the security files requested in the access command to the memory sub-system controller.

At operation 350, the processing logic can execute the power up initialization. In some embodiments, the processing logic can complete the L2P table rebuild along with other operations to get the media ready. In some embodiments, the processing logic can send a media ready indication or status to the memory sub-system controller after the power on initialization is complete. In such embodiments, the processing logic can access the PSMUs storing the +host system data after sending the media ready status—e.g., perform read, write, erases on the host system data.

At operation 360, the processing logic can optionally perform an ECC operation on the security file system stored at the reserved PSMU. In some embodiments, the local media controller can write the security file system to the reserved PSMU. In such embodiments, the local media controller may not perform many additional writes to the reserved PSMU. That is, a number of writes to the reserved PSMU can be significantly less than a number of writes to a PSMU storing host system data. Accordingly, the local media controller can refrain from performing wear leveling operations or other media management operations at the reserved PSMU. Instead of utilizing wear leveling operations, the local media controller can perform occasional ECC operations at the reserved PSMU to ensure there is no degradation. If the local media controller finds errors at the reserved PSMU as a result of an error correction operation, the local media controller can access a copy of the security system files. In some embodiments, the processing logic can store a copy of the security file system (e.g., a redundant copy or second copy) at a different reserved PSMU. The different reserved PSMU can also be separate from the host system data. If the local media controller detects the errors at the initial reserved PSMU, the local media controller can recover the security file system from the copy. In such embodiments, the local media controller can write the security file system to a new reserved PSMU (e.g., a third PSMU). Accordingly, the local media controller can swap the degraded PSMU with the new PSMU. The local media controller can access the third PSMU when receiving additional access commands for the security file system.

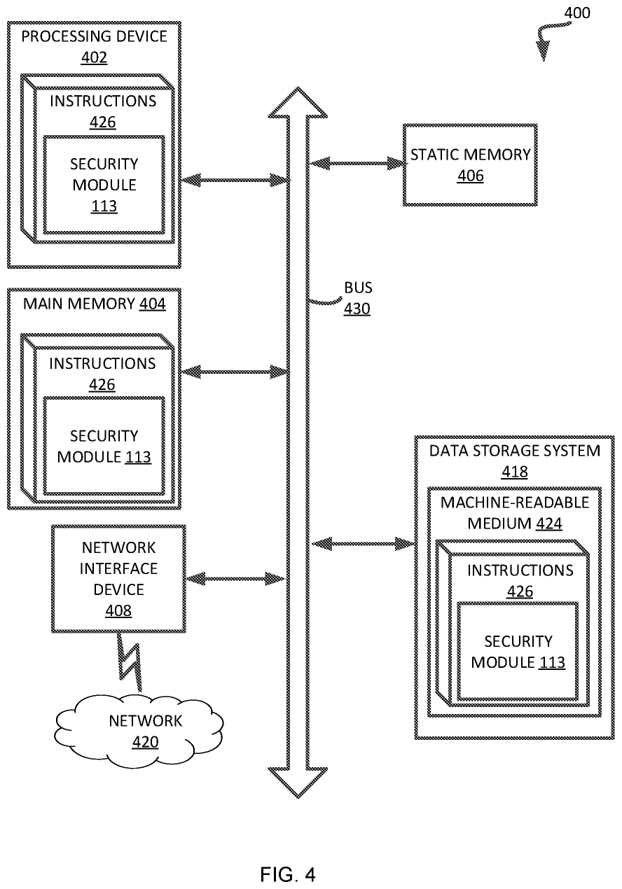

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the security module 113 of FIG. 1 to perform a security initialization). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 702 is configured to execute instructions 426 for performing the operations and steps discussed herein. The computer system 400 can further include a network interface device 608 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a security module 113 to initiate a security procedure for the processing device 402. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving, from a host system, an identification command;
responsive to receiving the identification command, initiating a security procedure;
transmitting an access command to the memory device, the access command comprising an identification of a first physical super management unit (PSMU) at a first location of the memory device storing a security file system, wherein data for the host system is stored at a second location of the memory device;
responsive to transmitting the access command, receiving one or more files from the security file system; and
executing the security procedure in response to receiving the one or more files.

2. The system of claim 1, wherein the processing device is to receive the identification command from the host system after a reset of the memory device.

3. The system of claim 1, wherein the processing device is to perform operations further comprising:
responsive to receiving the identification command, initiate a power on initialization procedure, wherein transmitting the access command is at least partially concurrent with executing the power on initialization.

4. The system of claim 1, wherein the processing device is to operations further comprising:
transmitting, to the host system, a response indicating a completion of the of the identification command.

5. The system of claim 1, wherein the processing device is to operations further comprising:
executing a rebuilding of a logical-to-physical (L2P) table at least partially concurrent with executing the security procedure.

6. The system of claim 5, wherein the processing device is to perform operations further comprising:
receiving, after receiving the files from the security file system, a ready notification associated with the second location of the memory device storing host data.

7. The system of claim 1, wherein a copy of the security file system is stored at a second physical super management unit (PSMU) at the first location of the memory device.

8. A method comprising:
receiving, from a host system, an identification command;
responsive to receiving the identification command, initiating a security procedure;
transmitting an access command, to the memory device, the access command comprising an identification of a first physical super management unit (PSMU) at a first location of the memory device storing a security file system, wherein data for the host system is stored at a second location of the memory device;
responsive to transmitting the access command, receiving one or more files from the security file system; and
executing the security procedure in response to receiving the one or more files.

9. The method of claim 8, wherein the identification command is received from the host system after a reset of the memory device.

10. The method of claim 8, further comprising:
responsive to receiving the identification command, initiate a power on initialization procedure, wherein transmitting the access command is at least partially concurrent with executing the power on initialization.

11. The method of claim 8, further comprising:
transmitting, to the host system, a response indicating a completion of the of the identification command.

12. The method of claim 8, further comprising:
executing a rebuilding of a logical-to-physical (L2P) table at least partially concurrent with executing the security procedure.

13. The method of claim 8, further comprising:
receiving, after receiving the files from the security file system, a ready status associated with the second location of the memory device storing host data.

14. The method of claim 8, wherein a copy of the security file system is stored at a second physical super management unit (PSMU) at the first location of the memory device.

15. A system comprising:
a memory device; and
a processing device, operatively coupled with the memory device, to perform operations comprising:
performing a power up initialization of the memory device;
receiving an access command with a file identification;
determining the access command is associated with a physical super management unit (PSMU) at a first location of the memory device storing a security file system based on the file identification;
transmitting security files stored at the PSMU in response to determining the access command is associated with the files, wherein transmitting the files is concurrent with executing the power initialization of the memory device.

16. The system of claim 15, wherein:
the memory device stores data for a host system at a second location of the memory device; and
the processing device is to perform operations further comprising:
refraining from performing a wear leveling operation on the PSMU storing the security file system.

17. The system of claim 16, wherein the processing device is to perform operations further comprising:
transmitting a ready status associated with the data stored at the second location of the memory device after transmitting the files stored at the PSMU.

18. The system of claim 15, wherein the memory device further stores a copy of the security file system at a second PSMU of the first location of the memory device.

19. The system of claim 16, wherein the processing device is to perform operations further comprising:
performing an error correction operation on the security file system stored at the PSMU of the first location of the memory device;
responsive to performing the error correction operation, determining one or more errors associated with the security file system; and
copying the security file system stored at the second PSMU at the first location of the memory device to a third PSMU at the first location of the memory device in response to determining the one or more errors.

20. The system of claim 15, wherein the processing device is to perform operations further comprising:
performing a rebuilding of a logical-to-physical (L2P) table at least partially concurrent with transmitting the files.
